(19) United States
(12) Patent Application Publication
(10) Pub. No.: US 2008/0313143 A1
(43) Pub. Date: Dec. 18, 2008

(54) APPARATUS AND METHOD FOR EVALUATING ACTIVITIES OF A HOSTILE FORCE

(75) Inventors: Brian Warn, Seattle, WA (US); Diana D. Yeu, Renton, WA (US); Leonard J. Quadracci, Seattle, WA (US); Jeffrey E. Hanneman, Kirkland, WA (US)

Correspondence Address: LAW OFFICE OF DONALD D. MONDUL, 3060 BONSAI DRIVE, PLANO, TX, 75093, US

(73) Assignee: Boeing Company, Chicago, IL (US)

(21) Appl. No.: 11/763,353

(22) Filed: Jun. 14, 2007

(51) Int. Cl. G06F 7/06; G06F 17/30

(52) U.S. Cl. 707/3; 707/E17.014

(57) ABSTRACT

An apparatus for evaluating hostile force activities includes: (a) a data storage device configured for identifying associative memory relations among information aspects stored in the data storage device; (b) a query device coupled with the data storage device; the query device being configured for posing queries relating to at least one of the information aspects and the associative memory relations to obtain at least one query result; and (c) an activity parsing unit coupled with at least one of the data storage device and the query device. The activity parsing unit is configured to receive information relating to the hostile force activities and is configured to effect identification of features related with the hostile force activities. The features related with the hostile force activities are available for inclusion among the information aspects. The data storage device periodically effects evaluation of the associative memory relations.

### FIELD OF THE INVENTION

One or more embodiments of the present invention are directed to uses of data devices that are useful for identifying associative memory relations among data entries, and especially to using such associative memory capable data devices in evaluating activities of a hostile force.

### BACKGROUND

Land forces in a high hostile threat environment face a continual challenge to extract actionable information from large volumes of current and historical free text or other intelligence data. Intelligence organizations collect vast amounts of data about hostile activities which occur within a given area of operations. The intelligence community cannot easily extract and present hostile activity trend information to front line forces in a timely manner. Typical reasons intelligence analysts cannot present critical intelligence information to users when needed include: (1) in some cases too much data exists to analyze, (2) in other cases the data is too sparse, (3) information patterns present in the data that relate to a current threat are not easy to identify, and (4) key historical lessons learned information are not readily accessible.

There is a need for an apparatus and method for evaluating activities of a hostile force that can enhance pattern recognition and other historical perspective understanding of activities of a hostile force to permit improved activity anticipation and handling.

### SUMMARY

An apparatus for evaluating activities of a hostile force includes: (a) a data storage device configured for identifying associative memory relations among information aspects stored in the data storage device; (b) a query device coupled with the data storage device; the query device being configured for posing queries relating to at least one of the information aspects and the associative memory relations to obtain at least one query result; and (c) an activity parsing unit coupled with at least one of the data storage device and the query device. The activity parsing unit is configured to receive information relating to the activities of a hostile unit and is configured to effect identification of features related with the activities of a hostile unit. The features related with the activities of a hostile force are available for inclusion among the information aspects. The data storage device periodically effects evaluation of the associative memory relations.

A method for evaluating activities of a hostile force includes: (a) in no particular order: (1) providing a data storage device; (2) providing a query device coupled with the data storage device; and (3) providing an activity parsing device coupled with at least one of the data storage device and the query device; (b) identifying associative memory relations among information aspects stored in the data storage device; (c) operating the activity parsing unit to receive information relating to the activities of a hostile force and to effect identification of features related with the activities of a hostile force; the features related with the activities of a hostile force being available for inclusion among the information aspects; (d) operating the query device to pose queries relating to at least one of the information aspects and the associative memory relations to obtain at least one query result; and (e) operating the data storage device to periodically effect updating of the associative memory relations.

It is, therefore, a feature of one or more embodiments of the invention to provide an apparatus and method for evaluating activities of a hostile force that may provide enhanced pattern recognition and/or other historical perspective understanding of activities of a hostile force to permit improved activity anticipation and handling.

Further features of the embodiments of the invention will be apparent from the following specification and claims when considered in connection with the accompanying drawings, in which like elements are labeled using like reference numerals in the various figures, illustrating embodiments of the invention.

### BRIEF DESCRIPTION OF THE DRAWINGS

FIG. 1 is a schematic illustration of an embodiment of the apparatus of the invention.

FIG. 2 is a flow chart illustrating an embodiment of the method of the invention.

### DETAILED DESCRIPTION

Associative memory learning technology may provide a new methodology for categorizing and prioritizing activity segments of activities of a hostile force. This technology may be applicable to a situation in which a high volume of intelligence reports must be processed rapidly to allow efficient and appropriate action by managers responsible for acting upon the information included in those intelligence reports. The technology may use trend information in historical intelligence data and information models for categorizing and prioritizing information included in activity segments received in the intelligence reports. Intelligence reports may include or originate from, by way of example and not by way of limitation, observation reports, human intelligence (HUMINT), intelligence imagery as from satellite observations, lessons learned from previous hostile actions, electronic intelligence (ELINT), e-mail intercepts, background and other briefings and other observations, intercepts and reports. Activities of a hostile force may include, by way of example and not by way of limitation, ambush, rocket-propelled grenade (RPG) attack, detonation of an improvised explosive device (IED), detonation by a suicide bomber or another activity seeking to interrupt friendly operations, damage friendly equipment or injure or kill friendly personnel.

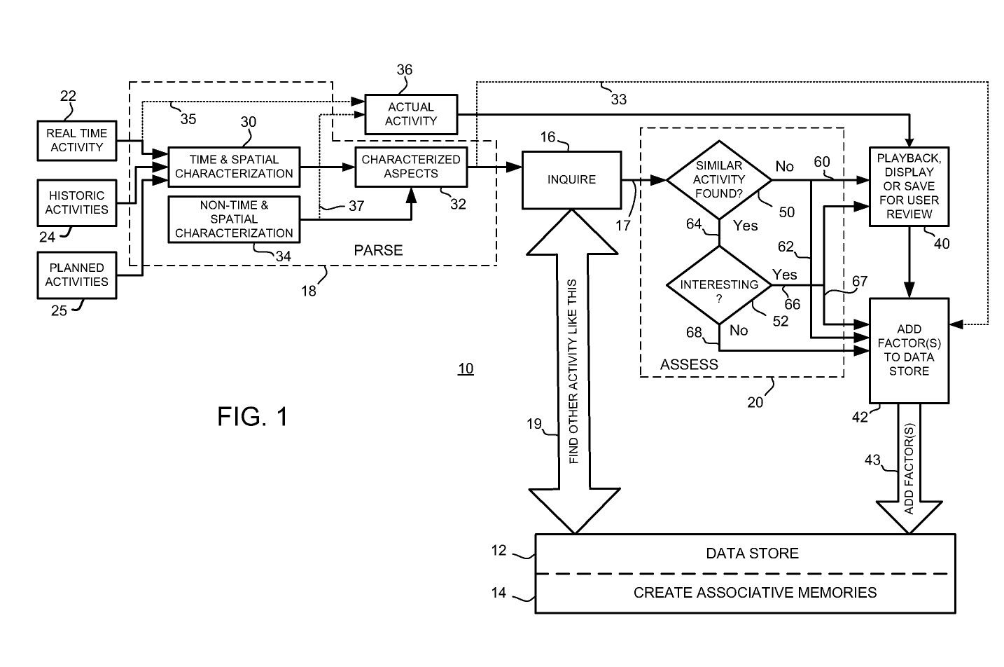

FIG. 1 is a schematic illustration of an embodiment of the invention. In FIG. 1, an apparatus 10 may include a data store 12 coupled with an associative memory unit 14. Data store 12 and associative memory unit 14 may be embodied in a single unitary device. Apparatus 10 may also include a query unit 16 coupled with at least one of data store 12 and associative memory unit 14. A parsing unit 18 may be coupled with query unit 16. An assessing unit 20 may be coupled with query unit 16 and coupled with at least one of data store 12 and associative memory unit 14.

A user review unit 40 may be coupled with assessing unit 20 for providing playback, display or another medium for reviewing activity indicators for a user's evaluation of activities by a hostile force. User review unit 40 may save activity indicators for later evaluation or analysis by a user. User review unit 40 may provide factors selected by a user or according to at least one predetermined criterion for provision to an input unit 42. Input unit 42 may provide selected factors relating to activity indicators received at activity input units 22, 24, 25 or otherwise received by apparatus 10, as indicated by an arrow 43. Other ways of receiving activity indicators may include, by way of example and not by way of limitation, on-line or off-line transmissions of activity indicators-related information to apparatus 10 from another intelligence source of the sort described above.

Parsing unit 18 may include a time and spatial activity characterization unit 30 coupled for receiving real time activity indicators from an activity source 22. Time and spatial activity characterization unit 30 may also be coupled for receiving historic activity indicators from an archival or historic activity source 24. Time and spatial activity characterization unit 30 may also be coupled for receiving planned activity indicators from a planned activity source 25. Using planned activity indicators may be helpful in planning future operations using the full capabilities of apparatus 10 for evaluating alternate operation parameters, routes, armament, transport equipment and other aspects relating to a future operation.

Time and spatial activity characterization unit 30 may treat activity indicators received from activity sources 22, 24, 25 to parse the received inputs to identify, quantify, digitally encode or otherwise treat time and space aspects of those inputs so as to present a set of characterized aspects 32 for use by query unit 16. Time and space activity characterized aspects may include, by way of example and not by way of limitation, representations of times, loci, travel routes or other time-related or space-related activity inputs received from one or more of activity sources 22, 24, 25.

A non-time and space activity characterization unit 34 may also be included in parsing unit 18. Non-time and space activity characterization unit 34 may treat non-time and space related activity factors associated with activity inputs received from activity sources 22, 24, 25. Non-time and space activity factors may be parsed by non-time and space activity characterization unit 34 to identify, quantify, digitally encode or otherwise treat aspects of those non-time and space activity factors for inclusion in the set of characterized aspects 32 for querying by query unit 16. Non-time and space activity characterized aspects may include, by way of example and not by way of limitation, occurrences of hostile action, friendly armament, friendly transportation, presence of friendly tanks or other heavy equipment, holidays extant at time of travel and other non-time and space aspects related to activity inputs received from one or more of activity sources 22, 24, 25.

For purposes of this disclosure, term “parse” may be taken to mean, “to examine closely or subject to detailed analysis, especially by breaking up in to components; to analyze or separate into more easily processed components”. Activity inputs may be received from any activity originator via any transmission method or device. By way of example and not by way of limitation, activity inputs received from activity sources 22, 24, 25 may be analog or digital and may be provided live, via telephone, via radio, in audio files received via e-mail, in compact disc (CD) or digital versatile disk (DVD) recordings of voice messages, in taped voice recordings, in recorded or live continuous wave (CW) messages (e.g., in Morse Code), in on-line word processing produces reports or any other activity input provided in real time or reproduced by some mechanism.

Actual or real-time untreated activity aspects may be provided directly from activity source 22 to an actual activity provision unit 36. Untreated activity aspects may include, by way of example and not by way of limitation, unedited video material, unedited intelligence reports or other unedited, unchanged or untreated activity aspects. Actual activity provision unit 36 may be coupled for providing actual activity information to user review unit 40. Non-time and space activity characterization unit 34 may provide non-time and space activity related information aspects to actual activity provision unit 36 for use by user review unit 40. The alternate nature of whether non-time and space activity information may be provided directly from activity source 22 to actual activity provision unit 36 is indicated by presenting line 35 in a dotted line format. The alternate nature of whether non-time and space activity information may be provided from non-time and space activity characterization unit 34 to actual activity provision unit 36 is indicated by presenting line 37 in a dotted line format.

Query unit 16 may inquire of the set of characterized aspects 32 and of at least one of data store 12 and associative memory unit 14 to develop at least one query result for presentation at an output locus 17. Queries posed by query unit 16 may relate to characterized aspects or other information presented from the set of characterized aspects 32. Query unit 16 may inquire of one or both of data store 12 and associative memory unit 14 to seek other activities of a hostile force similar to the extant activities of a hostile force represented by the set of characterized aspects 32 or some subset of the set of characterized aspects 32, as represented by an arrow 19. A result of the inquiry to at least one of data store 12 and associative memory unit 14 is presented as at least one query result presented at output locus 17.

Assessing unit 20 may include a logical query unit 50 and a logical query unit 52. Logical query unit 50 may be coupled to receive the at least one query result presented at output locus 17 to pose the query whether the at least one query result indicates that similar activity information has been found before. If no similar activity information has been found before, logical query unit 50 may provide an indication of the at least one query result to user review unit 40 and to input unit 42 via a NO response line 60. Logical query unit 50 may also provide an indication or factors relating to the at least one query result to input unit 42 via a line 62 for further provision of the indication of the at least one query result to at least one of data store 12 and associative memory unit 14. If similar activity information has been found before, logical query unit 50 may provide an indication of the at least one query result to logical query unit 52 via a YES response line 64.

Logical query unit 52 may query whether the at least one query result is interesting, as defined by predetermined criteria. If the at least one query result is deemed interesting, logical query unit 52 may provide an indication of the at least one query result to user review unit 40 and to input unit 42 via a YES response line 60. Logical query unit 52 may also provide an indication or factors relating to the at least one query result to input unit 42 via a line 67 for further provision of the indication of the at least one query result to at least one of data store 12 and associative memory unit 14. If the at least one query result is not deemed interesting, logical query unit 52 may provide an indication of the at least one query result to input unit 42 via a NO response line 68 for further provision of the indication of the at least one query result to at least one of data store 12 and associative memory unit 14.

Characterized aspects relating to activities of a hostile force may be presented directly from the set of characterized aspects 32 to input unit 42 via a line 33 for further provision of the characterized aspects to at least one of data store 12 and associative memory unit 14. The alternate nature of whether characterized aspects may be provided directly from the set of characterized aspects 32 to input unit 42 is indicated by line 33 being presented in a dotted line format.

Apparatus 10 may decompose activity segment free text received at activity sources 22, 24, 25 and may establish associations among aspects of activities of a hostile force within a single intelligence report or other source, or may establish associations among aspects of activities of a hostile force associated with other calls in a historical memory saved in data store 12. Associations may be ascertained among circumstances or sets of circumstances by associative memory unit 14 in cooperation with data store 12, and associations may be established as indicators of activity category or priority according to predetermined criteria. Apparatus 10 may derive relationships among decomposed activity segments to establish relationships among the decomposed activity segments and historical or otherwise identified elements that are not simple to establish simply by referring to intelligence reports or reviewing other information sources relating to activities of a hostile force.

Apparatus 10 may be advantageously employed to permit providing correlation among circumstances that an experienced person may recognize as indicating a hostile action may occur. However, a person newly arrived in a theater of operations may not have acquired sufficient experience to arrive at a similar recognition of a threat. Apparatus 10 may provide an alert to a new person and may provide information relating to how one may avoid a hostile action by changing an aspect of a future operation, such as by way of example and not by way of limitation, increasing number of heavy equipment units in a convoy, avoiding a particular place at a particular time, or changing other operational parameters. In such manner, apparatus 10 may be advantageously employed as a training or learning agent. An apparatus 10 may be “taught” relationships among factors that may permit a user merely to have query unit 16 inquire to the effect that data store 10 and associative memory unit 14 cooperate to respond by identifying activity segments “like this” (i.e., similar to an extant activity of a hostile force represented by the set of characterized aspects 32) for treatment in a particular way.

Employing data store 10 in cooperation with associative memory unit 14 may facilitate searching large sets of data regarding potential content of activities by a hostile force and identifying recurring patterns, key factors and other pre-identified characteristics. Apparatus 10 may further facilitate comparison of those pre-identified characteristics or indicators to an activity of a hostile force, or to a planned operation to evaluate likelihood of occurrence of hostile action. Comparison and evaluation of results may occur in real time or near-real time. Apparatus 10 may further facilitate parsing free text representing an intelligence report relating to activities by a hostile force to identify commonalities among hostile actions. Apparatus 10 may further facilitate identifying new patterns so that an activity by a hostile force may be categorized so that future activities or past activities of that category may be accurately recognized. Apparatus 10 may thereby continue to learn over time and become a better tool or better adjust to changing conditions.

Apparatus 10 may establish non-obvious relationships among circumstances or activities to identify probable situations and relationships with pre-identified critical categories requiring intervention or change. Such capabilities may result in opportunities to alter a plan of operation as critical situations are developing in order to preventively influence the course of events. Apparatus 10 may avoid a “key word or key phrased” based approach that requires precise queries or rules to exactly describe what causes a particular classification of an activity of a hostile force. The memory based approach employed by apparatus 10 may permit apparatus 10 to merely inquire for other hostile activities “like this” to categorize an extant activity segment without having to not know exactly why the extant activity segment is significant.

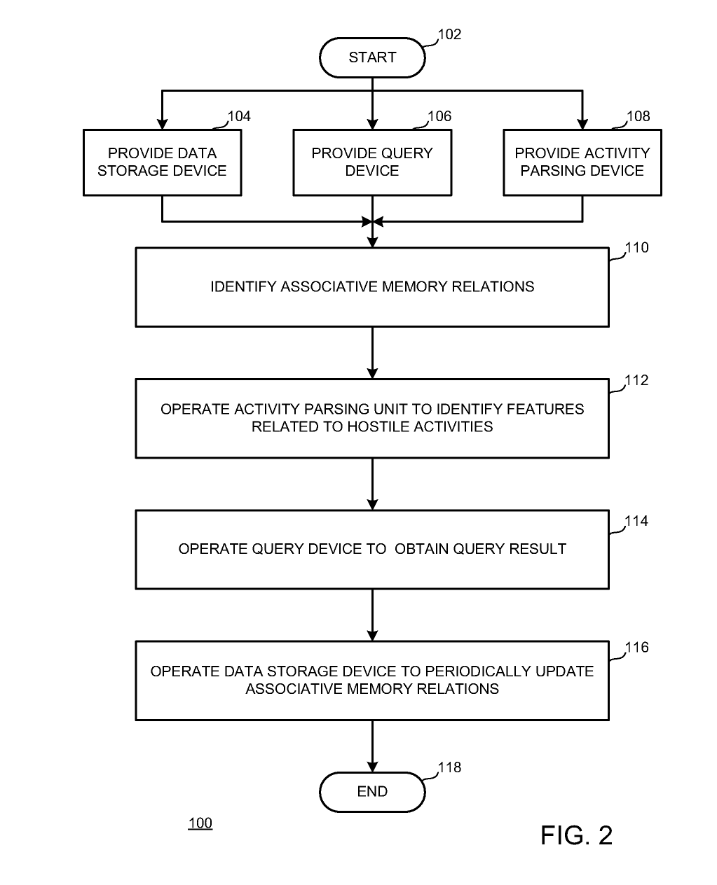

FIG. 2 is a flow chart illustrating an embodiment of the method of the invention. In FIG. 2, a method 100 for evaluating activities of a hostile force may begin at a START locus 102. Method 100 may continue by, in no particular order, with one or more of the following: (1) providing a data storage device, as indicated by a block 104; (2) providing a query device coupled with the data storage device, as indicated by a block 106; and (3) providing an activity parsing unit coupled with at least one of the data storage device and the query device, as indicated by a block 108.

Method 100 may then continue by identifying associative memory relations among information aspects stored in the data storage device, as indicated by a block 110. Method 100 continues with operating the activity parsing device to receive information relating to the activities of a hostile force and to effect identification of features related with the activities of a hostile force, as indicated by a block 112. The features related with the activities of a hostile force may be available for inclusion among the information aspects. Method 100 may continue by operating the query device to pose queries relating to at least one of the information aspects and the associative memory relations to obtain at least one query result, as indicated by a block 114. Method 100 may continue by operating the data storage device to periodically effect updating of the associative memory relations, as indicated by a block 116. Method 100 may terminate at an END locus 118.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims.

We claim:

1. An apparatus for evaluating activities of a hostile force; the apparatus comprising:
a parsing unit coupled for receiving information relating to said activities; said parsing unit identifying a plurality of predetermined aspects of said information relating to said activities;
a query unit coupled with said parsing unit for receiving said plurality of predetermined aspects; said query unit posing at least one query relating to at least one predetermined aspect of said plurality of predetermined aspects;
a data store coupled with said query unit; said data store storing a plurality of digital units representing said plurality of predetermined aspects;
an associative memory unit coupled with at least one of said data store and said query unit; said associative memory unit cooperating with said data store to identify a plurality of associative memory relations among selected digital units of said plurality of digital units; said query unit cooperating with at least one of said data store and said associative memory unit in developing at least one query result from said at least one query; and
an assessing unit coupled with said query unit and coupled with at least one of said data store and said associative memory unit; said assessing unit employing at least one first predetermined criterion with said at least one query result for determining whether said activities should be subjected to a special treatment,
wherein at least one of said parsing unit and said assessing unit selectively provide updating information relating to said plurality of predetermined aspects to at least one of said data store and said associative memory unit according to at least one second predetermined criterion, and
wherein said data store and said associative memory unit periodically cooperate to employ said updating information for effecting an evaluation of said plurality of associative memory relations.

2. The apparatus for evaluating activities of a hostile force as recited in claim 1,
wherein said data store and said associative memory unit are integrally embodied in a data storage device.

3. The apparatus for evaluating activities of a hostile force as recited in claim 1 wherein said parsing unit includes an activity characterization unit; said activity characterization unit identifying a plurality of activity characteristics relating to said activities of said hostile force; selected activity characteristics of said plurality of activity characteristics being included among said plurality of predetermined aspects.

4. The apparatus for evaluating activities of a hostile force as recited in claim 1 wherein said parsing unit includes a non-activity characterization unit; said non-activity characterization unit identifying a plurality of non-activity characteristics relating to said activities of said hostile force; selected non-activity characteristics of said plurality of non-activity characteristics being included among said plurality of predetermined aspects.

5. The apparatus for evaluating activities of a hostile force as recited in claim 1 wherein said assessing unit effects a query whether a respective said predetermined aspect of said plurality of predetermined aspects identified in said activities of said hostile force is a previously unencountered aspect; said previously unencountered aspect being a candidate for said special treatment.

6. The apparatus for evaluating activities of a hostile force as recited in claim 2 wherein said parsing unit includes an activity characterization unit; said activity characterization unit identifying a plurality of activity characteristics relating to said activities of said hostile force, and wherein said parsing unit includes a non-activity characterization unit; said non-activity characterization unit identifying a plurality of non-activity characteristics relating to said activities of said hostile force; selected activity characteristics of said plurality of activity characteristics being included among said plurality of predetermined aspects; selected non-activity characteristics of said plurality of non-activity characteristics being included among said plurality of predetermined aspects.

7. The apparatus for evaluating activities of a hostile force as recited in claim 6 wherein said assessing unit effects a query whether a respective said predetermined aspect of said plurality of predetermined aspects identified in said activities of said hostile force is a previously unencountered aspect; said previously unencountered aspect being a candidate for said special treatment.

8. An apparatus for evaluating activities of a hostile force; the apparatus comprising:
a data storage device; said data storage device being configured for identifying associative memory relations among information aspects stored in said data storage device;
a query device coupled with said data storage device; said query device being configured for posing queries relating to at least one of said information aspects and said associative memory relations to obtain at least one query result; and
an activity parsing unit coupled with at least one of said data storage device and said query device; said activity parsing unit being configured to receive information relating to said activities of said hostile force and being configured to effect identification of features related with said activities of said hostile force; said features related with said activities of said hostile force being available for inclusion among said information aspects, wherein said data storage device periodically effecting evaluation of said associative memory relations.

9. The apparatus for evaluating activities of a hostile force as recited in claim 8 wherein the apparatus further comprises: an assessing device coupled with at least one of said data storage device and said query device; said assessing unit employing at least one first predetermined criterion with said at least one query result for determining whether said activities of said hostile force should be subjected to special treatment;
at least one of said parsing device and said assessing device selectively providing updating information relating to said information aspects to said data storage device according to at least one second predetermined criterion.

10. The apparatus for evaluating activities of a hostile force as recited in claim 8 wherein said parsing unit includes an activity characterization unit; said activity characterization unit identifying a plurality of activity characteristics relating to said activities of said hostile force; selected activity characteristics of said plurality of activity characteristics being included among said information aspects.

11. The apparatus for evaluating activities of a hostile force as recited in claim 8 wherein said parsing unit includes a non-activity characterization unit; said non-activity characterization unit identifying a plurality of non-activity characteristics relating to said activities of said hostile force; selected non-activity characteristics of said plurality of non-activity characteristics being included among said information aspects.

12. The apparatus for evaluating activities of a hostile force as recited in claim 8 wherein said assessing unit effects a query whether a respective said information aspect of said information aspects identified in said activities of said hostile force is a previously unencountered aspect; said previously unencountered aspect being a candidate for said special treatment.

13. The apparatus for evaluating activities of a hostile force as recited in claim 9 wherein said parsing unit includes an activity characterization unit; said activity characterization unit identifying a plurality of activity characteristics relating to said activities of said hostile force, and wherein said parsing unit includes a non-activity characterization unit; said non-activity characterization unit identifying a plurality of non-activity characteristics relating to said activities of said hostile force; selected activity characteristics of said plurality of activity characteristics being included among said information aspects; selected non-activity characteristics of said plurality of non-activity characteristics being included among said information aspects.

14. The apparatus for evaluating activities of a hostile force as recited in claim 13 wherein
said assessing unit effects a query whether a respective said information aspect of said information aspects identified in said activities of said hostile force is a previously unencountered aspect; said previously unencountered aspect being a candidate for said special treatment.

15. A method for evaluating activities of a hostile force; the method comprising:
in no particular order:
(1) providing a data storage device;
(2) providing a query device coupled with said data storage device; and
(3) providing an activity parsing unit coupled with at least one of said data storage device and said query device;
identifying associative memory relations among information aspects stored in said data storage device;
operating said activity parsing device to receive information relating to said activities of said hostile force and to effect identification of features related with said activities of said hostile force; said features related with said activities of said hostile force being available for inclusion among said information aspects;
operating said query device to pose queries relating to at least one of said information aspects and said associative memory relations to obtain at least one query result; and
operating said data storage device to periodically effect updating of said associative memory relations.

16. The method for evaluating activities of a hostile force as recited in claim 15, wherein the method further comprises:
in no particular order:
providing an assessing device coupled with at least one of said data storage device and said query device; and
operating said assessing unit employing at least one first predetermined criterion with said at least one query result to determine whether said activities of said hostile force should be subjected to special treatment; and
operating at least one of said parsing device and said assessing device to selectively provide updating information relating to said information aspects to said data storage device according to at least one second predetermined criterion.

17. The method for evaluating activities of a hostile force as recited in claim 15 wherein said parsing unit includes an activity characterization unit; said activity characterization unit identifying a plurality of activity characteristics relating to said activities of said hostile force; selected activity characteristics of said plurality of activity characteristics being included among said information aspects.

18. The method for evaluating activities of a hostile force as recited in claim 15 wherein said parsing unit includes a non-activity characterization unit; said non-activity characterization unit identifying a plurality of non-activity characteristics relating to said activities of said hostile force; selected non-activity characteristics of said plurality of non-activity characteristics being included among said information aspects.

19. The method for evaluating activities of a hostile force as recited in claim 15 wherein said assessing unit effects a query whether a respective said information aspect of said information aspects identified in said activities of said hostile force is a previously unencountered aspect; said previously unencountered aspect being a candidate for said special treatment.

20. The method for evaluating activities of a hostile force as recited in claim 16 wherein said parsing unit includes an activity characterization unit; said activity characterization unit identifying a plurality of activity characteristics relating to said activities of said hostile force, and wherein said parsing unit includes a non-activity characterization unit; said non-activity characterization unit identifying a plurality of non-activity characteristics relating to said activities of said hostile force; selected activity characteristics of said plurality of activity characteristics being included among said information aspects; selected non-activity characteristics of said plurality of non-activity characteristics being included among said information aspects.
